(19) United States
(12) Patent Application Publication
(10) Pub. No.: US 2007/0154636 A1
(43) Pub. Date: Jul. 5, 2007

(54) SUBSTRATE PROCESSING METHOD AND SUBSTRATE PROCESSING APPARATUS

(76) Inventor: Akio Hashizume, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/565,698

(22) Filed: Dec. 1, 2006

(30) Foreign Application Priority Data
Dec. 2, 2005 (JP) 2005-349676
Oct. 6, 2006 (JP) 2006-275092

(51) Int. Cl. B05D 3/12; B05C 11/02; B05B 7/06

(52) U.S. Cl. 427/240; 118/52; 118/313

(57) ABSTRACT

According to the substrate processing method of the invention, a mixed fluid obtained by mixing an organic solvent and a gas is supplied to the surface of the substrate. Thereafter, a resist strip liquid to strip off the resist from the surface of the substrate is supplied to the surface of the substrate.

### BACKGROUND OF THE INVENTION

1. Field of the Invention

The present invention relates to a substrate processing method and a substrate processing apparatus applied to remove a resist from the surface of a substrate of various kinds represented by a semiconductor wafer, a glass substrate for a liquid crystal display, a glass substrate for a plasma display, a glass substrate for an FED (Field Emission Display), an optical disc substrate, a magnetic disc substrate, a magneto-optical disc substrate, a photomask substrate, and so forth.

2. Description of Related Art

The manufacturing process of a semiconductor device includes, for example, a step of locally implanting impurities (ions), such as phosphorous, arsenic, and boron, on the surface of a semiconductor wafer (hereinafter, referred to simply as the wafer). In this step, in order to prevent ions from being implanted in an undesired portion, a resist made of a photosensitive resin is formed in a pattern on the surface of the wafer, so that a portion where the ion implantation is not desired is masked by the resist. The resist formed in a pattern on the surface of the wafer is unnecessary after the ion implantation. Resist removing processing is therefore performed after the ion implantation to remove the unnecessary resist on the surface of the wafer by stripping.

In the resist removing processing, the resist on the surface of the wafer is removed, for example, by ashing in an ashing device. The wafer is then carried into a cleaning device to remove resist polymer remaining after the ashing from the surface of the wafer.

In the ashing device, for example, the inside of a processing chamber accommodating the wafer is brought into an oxygen gas atmosphere and a microwave is irradiated into the oxygen gas atmosphere. This gives rise to a plasma of the oxygen gas (oxygen plasma) within the processing chamber, and this oxygen plasma is irradiated on the surface of the wafer. The resist film on the surface of the wafer is consequently removed by decomposition.

In the cleaning device, for example, a chemical, such as APM (Ammonia-hydrogen Peroxide Mixture), is supplied to the surface of the wafer to apply cleaning processing (resist polymer removing processing) using the chemical to the surface of the wafer. The resist polymer adhering onto the surface of the wafer is removed by this cleaning processing.

Ashing using a plasma, however, has a problem that the surface of the wafer is damaged in a portion uncovered with the resist film (for example, an exposed oxide film).

Such being the case, as an alternative to the ashing by a plasma and the cleaning processing using a chemical, such as APM, it is proposed to supply SPM (Sulfuric acid/hydrogen Peroxide Mixture), which is a mixed liquid of sulfuric acid and a hydrogen peroxide liquid, to the surface of the wafer, so that the resist formed on the surface of the wafer is removed by stripping with a strong oxidation force of peroxomonosulfuric acid (H₂SO₅) contained in the SPM.

However, because the surface of the resist has been altered (hardened) in an ion-implanted wafer (in particular, in the case of a high-dose ion implantation), the resist cannot be removed in a satisfactory manner or it takes time to remove the resist.

### SUMMARY OF THE INVENTION

An object of the invention is therefore to provide a substrate processing method and a substrate processing apparatus that enable to strip off (remove) the resist used as the mask during the ion implantation in a satisfactory manner without giving damage to the substrate.

A substrate processing method of the invention includes a mixed fluid supplying step of supplying a mixed fluid obtained by mixing an organic solvent and a gas to a surface of a substrate, and a resist strip liquid supplying step of supplying a resist strip liquid to the surface of the substrate after the mixed fluid supplying step for stripping off a resist from the surface of the substrate.

A mixed fluid generated by mixing the organic solvent and the gas has a large energy (a physical action of the fluid when it collides on the surface of the substrate and a chemical action of the organic solvent). Hence, by supplying the mixed fluid to the surface of the substrate, even when the hardened layer is formed on the surface of the resist, it is possible to break the hardened layer. By supplying the resist strip liquid to the surface of the substrate after the mixed fluid is supplied to the surface of the substrate, the resist strip liquid can penetrate into the inside of the resist from broken portions of the hardened layer. It is thus possible to remove the resist having the hardened layer formed on the surface of the substrate to be processed in a satisfactory manner with the use of the resist strip liquid even when the substrate has not undergone an ashing processing to remove the resist containing the hardened layer by ashing. In addition, because the ashing is unnecessary, a problem of damage arising from the ashing can be avoided.

The substrate processing method can be performed by a substrate processing apparatus, including: a substrate holding mechanism that holds a substrate; a mixed fluid supplying mechanism that generates a mixed fluid by mixing an organic solvent and a gas and supplies the mixed fluid to a surface of the substrate held by the substrate holding mechanism; a resist strip liquid supplying mechanism that supplies a resist strip liquid to the surface of the substrate held by the substrate holding mechanism for stripping off a resist from the surface of the substrate; and a control unit that controls the mixed fluid supplying mechanism and the resist strip liquid supplying mechanism, so that the resist strip liquid supplying mechanism supplies the resist strip liquid after the mixed fluid is supplied by the mixed fluid supplying mechanism.

It is preferable for the substrate processing method to further include a substrate rotating step of rotating the substrate, and a liquid supplying step of supplying a liquid to the surface of the substrate in parallel with the substrate rotating step, and the liquid supplying step is performed in parallel with the mixed fluid supplying step.

A substrate processing apparatus to perform this substrate processing method includes, in addition to the configuration described above, a substrate rotating mechanism that rotates the substrate held by the substrate holding mechanism, and a liquid supplying mechanism that supplies a liquid to the surface of the substrate held by the substrate holding mechanism. The control unit controls the mixed fluid supplying mechanism, the substrate rotating mechanism, and the liquid supplying mechanism, so that the liquid is supplied to the surface of the substrate by the liquid supplying mechanism while the substrate is rotated in parallel with a supply of the mixed fluid by the mixed fluid supplying mechanism.

A liquid is supplied to the surface of the substrate while the substrate is rotated. The liquid supplied to the surface of the substrate flows over the surface of the substrate toward the outer periphery of the substrate by a centrifugal force induced by the rotations of the substrate. Pieces of the hardened layer of the resist broken by the supply of the mixed fluid are thus removed from the surface of the substrate by being flown with the liquid flowing over the surface of the substrate toward the outer periphery. It is thus possible to prevent the pieces of the broken hardened layer from adhering again onto the surface of the substrate.

Also, it is preferable that the resist strip liquid includes amixed liquid of sulfuric acid and a hydrogen peroxide liquid.

By supplying a mixed liquid of sulfuric acid and a hydrogen peroxide liquid, that is, SPM, to the surface of the substrate, it is possible to strip off the resist formed on the surface of the substrate in a satisfactory manner with a strong oxidation force of peroxomonosulfuric acid contained in the SPM.

The mixed fluid supplying step may be a step of supplying a jet of droplets generated from the gas and a liquid of the organic solvent.

Alternatively, the mixed fluid supplying step may be a step of supplying a mixed fluid obtained by mixing the gas and a vapor of the organic solvent.

As has been described, the mixed fluid can be a jet of droplets made of a gas and a liquid of the organic solvent or a vapor of fluid made of a gas and a vapor of the organic solvent. Because a jet of droplets made of a gas and a liquid of the organic solvent has a larger physical energy than a vapor of the fluid made of a gas and a vapor of the organic solvent, it is possible to break the hardened layer on the surface of the resist in a more satisfactory manner. Meanwhile, a vapor of fluid made of a gas and a vapor of the organic solvent has a smaller physical action when it collides on the surface of the substrate than a jet of droplets made of a gas and a liquid of the organic solvent. It is therefore possible to suppress a destruction of the pattern formed on the surface of the substrate. In addition, a vapor of fluid made of a gas and a vapor of the organic solvent can be eliminated swiftly from the periphery of the substrate by exhausting air from the periphery of the substrate.

Further, the organic solvent and/or the gas may be heated to temperatures lower than the ignition point of the organic solvent. In this case, it is possible to further increase the energy of the mixed fluid, which in turn makes it possible to break the hardened layer on the surface of the resist in a more satisfactory manner.

The above and other objects, features, and advantages of the invention will become more apparent from the following description of embodiments with reference to the accompanying drawings.

### BRIEF DESCRIPTION OF THE DRAWINGS

FIG. 1 is a view schematically showing a configuration of a substrate processing apparatus according to one embodiment of the invention;

FIG. 2 is a schematic cross section of a two fluid nozzle shown in FIG. 1;

FIG. 3 is a block diagram showing an electric configuration of the substrate processing apparatus shown in FIG. 1;

FIG. 4 is a view to describe processing in the substrate processing apparatus shown in FIG. 1; and

FIG. 5 is a graph showing the results of resist strip tests.

### DETAILED DESCRIPTION OF THE PREFERRED EMBODIMENTS

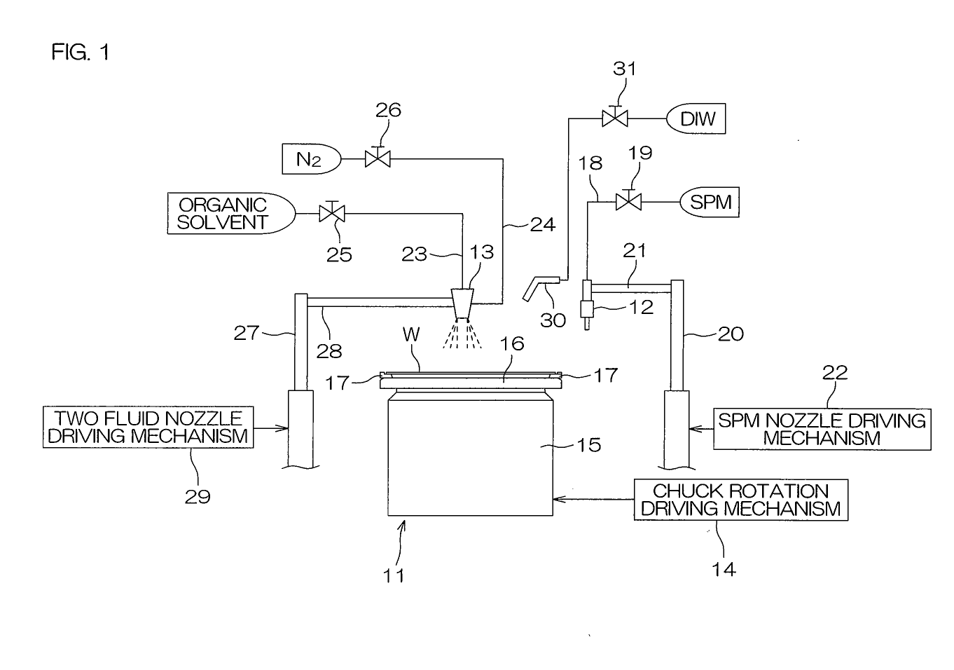

FIG. 1 is a view schematically showing a configuration of a substrate processing apparatus according to one embodiment of the invention. This substrate processing apparatus is, for example, an apparatus of a single-substrate processing type that performs processing to remove an unnecessary resist from the surface of a semiconductor wafer W (hereinafter, referred to simply as the wafer W) as an example of substrates by stripping after the ion implantation processing to implant impurities on the surface of the wafer W. The substrate processing apparatus includes a spin chuck 11 that rotates while holding the wafer W in almost a horizontal posture, an SPM nozzle 12 to supply SPM as a resist strip liquid to the surface (top surface) of the wafer W held by the spin chuck 11, a two fluid nozzle 13 to supply a mixed fluid of a liquid of organic solvent and a nitrogen gas to the surface of the wafer W held by the spin chuck 11, and a DIW (deionized water) nozzle 30 to supply a continuous flow of DIW to the surface of the wafer W held by the spin chuck 11.

The spin chuck 11 includes an almost disc-shaped spin base 16 and a plurality of holder members 17 to hold the wafer W almost in a horizontal posture. The spin base 16 is fixed to the top end of a rotating shaft 15 rotated by a chuck rotation driving mechanism 14. The holder members 17 are provided to plural points on the rim portion of the spin base 16 at nearly equiangular intervals. By rotation of the rotating shaft 15 by the chuck rotation driving mechanism 14 while the wafer W is held by the holder members 17, it is possible to rotate the wafer W together with the spin base 16 about the central axis line of the rotating shaft 15 while being kept almost in a horizontal posture.

The spin chuck 11 is not limited to the one configured as above, and for example, a vacuum chuck of a vacuum suction type may be adopted. The vacuum chuck holds the wafer W in a horizontal posture by vacuum-sucking to the back surface (non-device surface) of the wafer W, and is further able to rotate the wafer W being held by rotating about the vertical axis line while keeping this holding state.

The SPM nozzle 12 is, for example, a straight nozzle that discharges SPM in the state of a continuous flow. An SPM supply pipe 18 is connected to the SPM nozzle 12. Hot SPM at about 80° C. or higher capable of stripping off the resist on the surface of the wafer W in a satisfactory manner is supplied to the SPM nozzle 12 through the SPM supply pipe 18. An SPM valve 19 to control a supply of the SPM to the SPM nozzle 12 is interposed in the SPM supply pipe 18.

The SPM nozzle 12 is also a scan nozzle capable of changing the supply position of the SPM on the surface of the wafer W. A first rotating shaft 20 is disposed on a side of the spin chuck 11 almost along the vertical direction. The SPM nozzle 12 is attached to the distal end portion of a first arm 21 extending almost horizontally from the top end portion of the first rotating shaft 20. An SPM nozzle driving mechanism 22 that rotates the first rotating shaft 20 about the central axis line within a predetermined angular range is coupled to the first rotating shaft 20. By inputting a driving force into the first rotating shaft 20 from the SPM nozzle driving mechanism 22 to rotate the first rotating shaft 20 about the central axis line within the predetermined angular range, it is possible to oscillate the first arm 21 above the wafer W held by the spin chuck 11. By oscillating the first arm 21, it is possible to scan (move) the supply position of the SPM from the SPM nozzle 12 on the surface of the wafer W held by the spin chuck 11.

An organic solvent supply pipe 23 through which a pressurized liquid of organic liquid is supplied from an organic solvent supply source and a nitrogen gas supply pipe 24 through which a pressurized nitrogen gas is supplied from a nitrogen gas supply source are connected to the two fluid nozzle 13. An organic solvent valve 25 is interposed in midstream of the organic solvent supply pipe 23. Meanwhile, a nitrogen gas valve 26 is interposed in midstream of the nitrogen gas supply pipe 24. When the organic solvent valve 25 and the nitrogen gas valve 26 are opened, liquid of the organic solvent and nitrogen gas start to flow through the organic solvent supply pipe 23 and the nitrogen gas supply pipe 24, respectively. The liquid of the organic solvent and the nitrogen gas are thus supplied to the two fluid nozzle 13. The liquid of the organic solvent and the nitrogen gas are mixed with each other at the two fluid nozzle 13, to form fine droplets. A jet of these droplets is thus supplied to the surface of the wafer W held by the spin chuck 11 from the two fluid nozzle 13.

Examples of the organic solvent supplied to the two fluid nozzle 13 include IPA (isopropyl alcohol), NMP (N-methyl-2-pyrrolidone), acetone, cyclohexanone, and cyclohexane.

In addition, a second rotating shaft 27 is disposed on a side of the spin chuck 11 almost along the vertical direction. The two fluid nozzle 13 is attached to the distal end portion of a second arm 28 extending almost horizontally from the top end portion of the second rotating shaft 27. A two fluid nozzle driving mechanism 29 that rotates the second rotating shaft 27 about the central axis line within a predetermined angular range is coupled to the second rotating shaft 27. By inputting a driving force to the second rotating shat 27 from the two fluid nozzle driving mechanism 29 to rotate the second rotating shaft 27 about the central axis line within the predetermined angular range, it is possible to oscillate the second arm 28 above the wafer W held by the spin chuck 11. By oscillating the second arm 28, it is possible to scan (move) the supply position of a jet of droplets from the two fluid nozzle 13 on the surface of the wafer W held by the spin chuck 11.

DIW is supplied to the DIW nozzle 30 via a DIW valve 31.

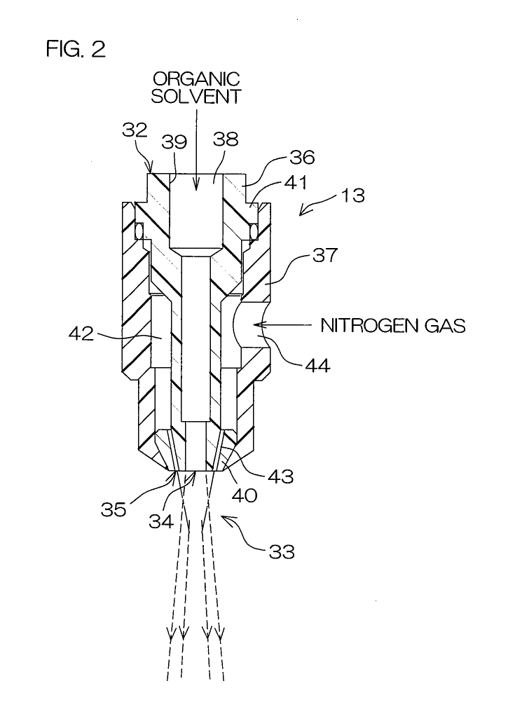

FIG. 2 is a schematic cross section showing a configuration of the two fluid nozzle 13. The two fluid nozzle 13 has a configuration of, for example, a so-called external-mixing type two fluid nozzle.

The two fluid nozzle 13 includes a casing 32. An organic solvent discharge port 34 to discharge the organic solvent toward an external space 33 and a nitrogen gas discharge port 35 formed in an annular shape surrounding the organic solvent discharge port 34 to discharge nitrogen gas toward the external space 33 are formed in the lower end of the casing 32.

To be more concrete, the casing 32 comprises an inner distribution pipe 36 and an outer holder 37 that surrounds the circumference of the inner distribution pipe 36 and holds the inner distribution pipe 36 coaxially in an interpolated state.

The inner distribution pipe 36 has an organic solvent channel 38 inside. The tip end (lower end) of the organic solvent channel 38 is opened as the organic solvent discharge port 34. An organic solvent introduction port 39 to introduce the organic solvent is formed on the upper end of the organic solvent channel 38 on the opposite side. The inner distribution pipe 36 is formed in the shape of a brim with the tip end portion (lower end portion) 40 and the upper end portion 41 on the opposite side overhanging outwards. The tip end portion 40 and the upper end portion 41 abut on the inner surface of the outer holder 37. A space 42 is defined between the outer surface of the inner distribution pipe 36 and the inner surface of the outer holder 37 from the tip end portion 40 to the upper end portion 41. A nitrogen gas channel 43 that communicates the space 42 and the external space 33 with each other is formed in the tip end portion 40 of the inner distribution channel 36. The tip end of the nitrogen gas channel 43 is opened as the nitrogen gas discharge port 35. The nitrogen gas channel 43 has an inclined sectional shape so that the tip end side comes closer to the central axis line of the inner distribution pipe 36.

The outer holder 37 has a nitrogen gas introduction port 44 on the side surface. The nitrogen gas introduction port 44 communicates with the space 42 defined between the outer surface of the inner distribution pipe 36 and the inner surface of the outer holder 37.

The organic solvent supply pipe 23 is connected to the organic solvent introduction port 39 and the nitrogen gas supply pipe 24 is connected to the nitrogen gas introduction port 44. When the organic solvent is supplied to the organic solvent channel 38 through the organic solvent supply pipe 23 and also a nitrogen gas is supplied to the space 42 through the nitrogen gas supply pipe 24, the organic solvent is discharged into the external space 33 from the organic solvent discharge port 34 and also the nitrogen gas is discharged into the external space 33 from the nitrogen gas discharge port 35. The organic solvent and the nitrogen gas then collide to be mixed within the external space 33 and the organic solvent forms into fine droplets. Consequently, a jet of droplets thereof is formed.

It should be noted that the two fluid nozzle 13 is not limited to the one having the configuration of the external-mixing type two fluid nozzle, and it may have the configuration of a so-called internal-mixing type two fluid nozzle.

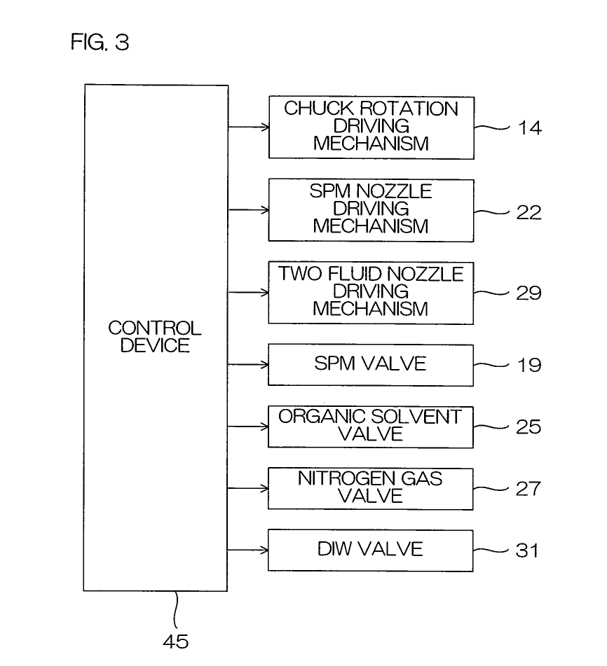

FIG. 3 is a block diagram showing an electrical configuration of the substrate processing apparatus. The substrate processing apparatus further includes a control device 45 configured to have a micro computer.

The chuck rotation driving mechanism 14, the SPM nozzle driving mechanism 22, the two fluid nozzle driving mechanism 29, the SPM valve 19, the organic solvent valve 25, the nitrogen gas valve 26, and the DIW valve 31 are connected to the control device 45 as subjects to be controlled. The control device 45 controls the operations of the chuck rotation driving mechanism 14, the SPM nozzle driving mechanism 22, and the two-fluid nozzle driving mechanism 29 according to a pre-determined program. Also, the control device 45 controls the SPM valve 19, the organic solvent valves 25, the nitrogen gas valve 26, and the DIW valve 31 to open and close.

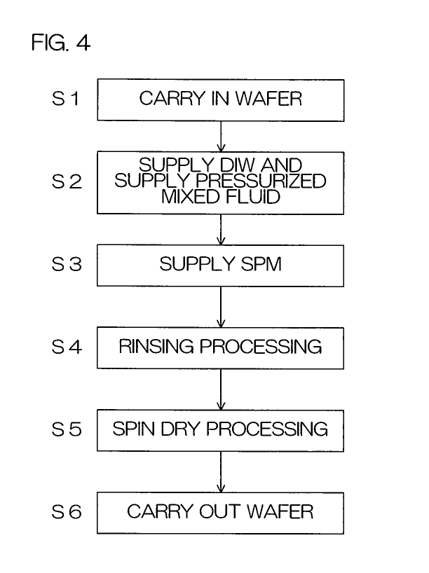

FIG. 4 is a view to describe the processing on the wafer W. The wafer W after the ion implantation processing is carried in by an unillustrated transportation robot. The wafer W is then held by the spin chuck 11 in a state where the surface on which the resist is formed faces upward (Step S1). The wafer W to be processed has not undergone the processing to ash the resist. A hardened layer resulting from alteration caused by the ion implantation is therefore formed on the surface of the resist.

Since the chuck rotation driving mechanism 14 is controlled, the wafer W held by the spin chuck 11 is rotated at a predetermined rotation speed (for example, 100 rpm). The DIW valve 31 is then opened, and DIW in the state of a continuous flow is supplied to the surface of the rotating wafer W from the DIW nozzle 30. Also, since the two fluid nozzle driving mechanism 29 is controlled, the two fluid nozzle 13 is moved above the wafer W held by the spin chuck 11 from the stand-by position set on a side of the spin chuck 11. Thereafter, the organic solvent valve 25 and the nitrogen gas valve 26 are opened, and a jet of droplets generated by mixing a liquid of the organic solvent and a nitrogen gas is discharged from the two fluid nozzle 13. Meanwhile, since the two fluid nozzle driving mechanism 29 is controlled, the second arm 28 is oscillated within a predetermined angular range. Accordingly, the supply position on the surface of the wafer W to which a jet of droplets is introduced from the two fluid nozzle 13 moves while drawing an arc-shaped trajectory within a range from the center of rotation of the wafer W to the rim portion of the wafer W. As a result, the jet of droplets is supplied to the entire surface of the wafer W without any irregularity (Step S2). The hardened layer formed on the surface of the resist is broken by an impact when the jet of droplets collides on the surface of the wafer W and a chemical action of the organic solvent. While the jet of droplets is supplied to the surface of the wafer W, a continuous flow of DIW is kept supplied to the wafer W from the DIW nozzle 30.

When reciprocal scanning of the jet supply position is performed a predetermined number of times, the organic solvent valve 25, the nitrogen gas valve 26, and the DIW valve 31 are closed, and the supply of a jet of droplets from the two fluid nozzle 13 and the supply of a continuous flow of DIW from the DIW nozzle 30 are stopped. The two fluid nozzle 13 is then returned to the stand-by position on a side of the spin chuck 11 from above of the wafer W.

Thereafter, the SPM nozzle driving mechanism 22 is controlled, then the SPM nozzle 12 is moved above the wafer W held by the spin chuck 11 from the stand-by position set on a side of the spin chuck 11. Since the SPM valve 19 is then opened, hot SPM is supplied to the surface of the rotating wafer W from the SPM nozzle 12. Meanwhile, the SPM nozzle driving mechanism 22 is controlled, then the first arm 21 is oscillated within a predetermined angular range. Accordingly, the supply position on the surface of the wafer W to which SPM from the SPM nozzle 12 is introduced moves while drawing an arc-shaped trajectory within a range from the center of rotation of the wafer W to the rim portion of the wafer W. As a result, the SPM is supplied to the entire surface of the wafer W without any irregularity (Step S3).

Because the hardened layer on the surface of the resist has been broken by the supply of the jet of droplets, the hot SPM supplied to the surface of the wafer W can penetrate into the inside of the resist from the broken portions of the hardened layer. It is thus possible to remove the unnecessary resist formed on the surface of the wafer W in a satisfactory manner with an oxidation force of the SPM even when the wafer W to be processed has not undergone the ashing processing to remove the resist including the hardened layer by ashing.

When the reciprocal scanning of the SPM supply position is performed a predetermined number of times, the SPM valve 19 is closed and a supply of the SPM to the wafer W is stopped. The SPM nozzle 12 is then returned to the stand-by position on a side of the spin chuck 11.

Thereafter, the DIW valve 31 is opened again, and DIW is supplied to the surface of the wafer W from the DIW nozzle 30. The SPM adhering onto the surface of the wafer W is rinsed away with the DIW (Step S4).

When a supply of the DIW is continued over a certain time, since the DIW valve 31 is closed, the supply of the DIW is stopped. Subsequently, processing (spin dry processing) is performed, by which the wafer W is dried by spinning off the DIW adhering onto the wafer W by a centrifugal force induced by rotations at a high rotation speed (for example, 3000 rpm) (Step S5).

When this processing is completed, the rotations of the wafer W by the spin chuck 11 are stopped by controlling the chuck rotation driving mechanism 14. Thereafter, the processed wafer W is carried out by the unillustrated transportation robot (Step S6).

A jet of droplets generated by mixing a liquid of the organic solvent and the nitrogen gas has a large energy (a physical action of the jet of droplets when they collied on the surface of the wafer W and a chemical action of the organic solvent). Hence, by supplying a jet of droplets to the surface of the wafer W, even when the hardened layer is formed on the surface of the resist over the surface of the wafer W, it is possible to break the hardened layer. By supplying the SPM to the surface of the wafer W after the hardened layer is broken, the SPM can penetrate into the inside of the resist from broken portions of the hardened layer. It is thus possible to remove the resist having the hardened layer formed on the surface of the wafer W in a satisfactory manner with the use of the SPM even when the wafer W has not undergone the ashing processing to remove the hardened layer. In addition, because the ashing is unnecessary, a problem of damage arising from the ashing can be avoided.

Since a continuous flow of DIW is supplied to the surface of the rotating wafer W while a jet of droplets is supplied to the surface of the wafer W, the surface of the wafer W is covered with the DIW, and the DIW flows over the surface of the wafer W toward the outer periphery of the wafer W by a centrifugal force induced by the rotations of the wafer W. Pieces of the broken hardened layer are thus removed from the surface of the wafer W together with the DIW flowing over the surface of the wafer W toward the outer periphery. It is thus possible to prevent the pieces of the broken hardened layer from adhering again onto the surface of the wafer W.

The embodiment above has described a case where a liquid of the organic solvent is supplied to the two fluid nozzle 13 as an example. However, the organic solvent is not limited to a liquid phase, and it may be supplied to the two fluid nozzle 13 in the form of vapor. In a case where a vapor of the organic solvent is supplied to the two fluid nozzle 13, a mixed fluid is generated from the vapor of the organic solvent and the nitrogen gas at the two fluid nozzle 13. Since this mixed fluid is in the form of vapor and has a smaller physical action when it collides on the surface of the wafer W than a jet of droplets made of a liquid of the organic solvent and the nitrogen gas, it is possible to suppress a destruction of the pattern formed on the surface of the wafer W. In addition, it is possible to eliminate a vapor of the mixed fluid made of a vapor of the organic solvent and the nitrogen gas swiftly from the periphery of the wafer W (the periphery of the spin chuck 11) when it is supplied to the surface of the wafer W from the two fluid nozzle 13 provided that air is exhausted from the periphery of the wafer W. Meanwhile, because a jet of droplets made of a gas and a liquid of the organic solvent has larger physical energy than a vapor of the mixed fluid made of a gas and a vapor of the organic solvent, it is possible to break the hardened layer on the surface of the resist in a more satisfactory manner.

In addition, a heater may be interposed in midstream of the organic solvent supply pipe 23 and/or the nitrogen gas supply pipe 24 to heat the organic solvent and/or the nitrogen gas supplied to the two fluid nozzle 13 to temperatures lower than the ignition point of the organic solvent. In this case, the energy of the mixed fluid can be further increased, which in turn makes it possible to break the hardened layer on the surface of the resist in a more satisfactory manner.

Also, instead of the nitrogen gas, helium gas, or argon gas, or a mixed gas of nitrogen and hydrogen, or carbon dioxide gas may be supplied to the two fluid nozzle 13.

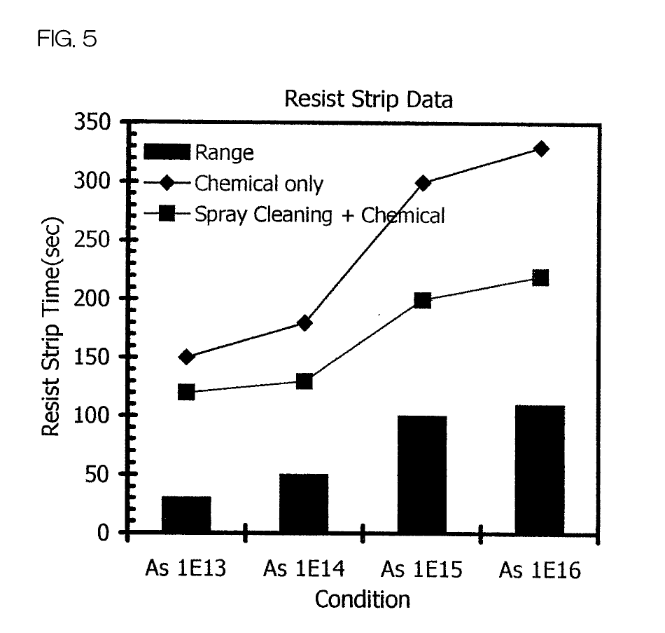

FIG. 5 is a graph showing the results of the resist strip tests.

Samples 1 through 4 were prepared, and tests A1 through A4 and B1 through B4 to strip off (remove) the resist from the respective Samples 1 through 4 were conducted.

Sample 1: a resist pattern for a KrF (krypton fluoride) excimer laser was formed on a surface of the wafer W, and As (arsenic) was doped on the surface of the wafer W by means of ion implantation at a dose amount of 1E13 atoms/cm² using the resist as a mask.

Sample 2: a resist pattern for an I-line was formed on a surface of the wafer W, and As was doped on the surface of the wafer W by means of ion implantation at a dose amount of 1E14 atoms/cm² using the resist as a mask.

Sample 3: a resist pattern for an I-line was formed on a surface of the wafer W, and As was doped on the surface of the wafer W by means of ion implantation at a dose amount of 1E15 atoms/cm² using the resist as a mask.

Sample 4: a resist pattern for a KrF excimer laser was formed on the surface of the wafer W, and As was doped on the surface of the wafer W by means of ion implantation at a dose amount of 1E16 atoms/cm² using the resist as a mask.

SPM used in the tests A1 through B4 was obtained by mixing sulfuric acid (concentration: 96 wt %) at the temperature of 80° C. and DIW at the temperature of 25° C. at a volume ratio of 2:1.

(Test A1)

The SPM was supplied to the surface of the wafer W of Sample 1 at a flow rate of 0.9 l/min from an SPM nozzle 12, and a time since the supply of the SPM was started until the resist was stripped off (resist strip time) was measured. The time was 150 seconds.

(Test B1)

After a jet of droplets generated by mixing an organic solvent (acetone) and a nitrogen gas was supplied to the surface of the wafer W of Sample 1 from the two fluid nozzle 13 for 40 seconds, the SPM was supplied from the SPM nozzle 12. A time since the supply of the jet of droplets was started until the resist was stripped off (resist strip time) was measured. Herein, the organic solvent was supplied to the two fluid nozzle 13 at a flow rate of 100 ml/min and a nitrogen gas was also supplied at a flow rate of 80 l/min. The time since the supply of the jet of droplets was started until the resist was stripped off was 120 seconds and the time is shortened by 30 seconds in comparison with the time measured in the test A1.

(Test A2)

The SPM was supplied to the surface of the wafer W of Sample 2 at a flow rate of 0.9 l/min from an SPM nozzle 12, and a time since the supply of the SPM was started until the resist was stripped off (resist strip time) was measured. The time was 180 seconds.

(Test B2)

After a jet of droplets generated by mixing an organic solvent (acetone) and a nitrogen gas was supplied to the surface of the wafer W of Sample 2 from the two fluid nozzle 13 for 40 seconds, the SPM was supplied from the SPM nozzle 12. A time since the supply of the jet of droplets was started until the resist was stripped off (resist strip time) was measured. Herein, the organic solvent was supplied to the two fluid nozzle 13 at a flow rate of 100 ml/min and a nitrogen gas was also supplied at a flow rate of 80 l/min. The time since the supply of the jet of droplets was started until the resist was stripped off was 130 seconds and the time is shortened by 50 seconds in comparison with the time measured in the test A2.

(Test A3)

The SPM was supplied to the surface of the wafer W of Sample 3 at a flow rate of 0.9 l/min from an SPM nozzle 12, and a time since the supply of the SPM was started until the resist was stripped off (resist strip time) was measured. The time was 300 seconds.

(Test B3)

After a jet of droplets generated by mixing an organic solvent (acetone) and a nitrogen gas was supplied to the surface of the wafer W of Sample 3 from the two fluid nozzle 13 for 40 seconds, the SPM was supplied from the SPM nozzle 12. A time since the supply of the jet of droplets was started until the resist was stripped off (resist strip time) was measured. Herein, the organic solvent was supplied to the two fluid nozzle 13 at a flow rate of 100 ml/min and a nitrogen gas was also supplied at a flow rate of 80 l/min. The time since the supply of the jet of droplets was started until the resist was stripped off was 200 seconds and the time is shortened by 100 seconds in comparison with the time measured in the test A3.

(Test A4)

The SPM was supplied to the surface of the wafer W of Sample 4 at a flow rate of 0.9 l/min from an SPM nozzle 12, and a time since the supply of the SPM was started until the resist was stripped off (resist strip time) was measured. The time was 330 seconds.

(Test B4)

After a jet of droplets generated by mixing an organic solvent (acetone) and a nitrogen gas was supplied to the surface of the wafer W of Sample 4 from the two fluid nozzle 13 for 40 seconds, the SPM was supplied from the SPM nozzle 12. A time since the supply of the jet of droplets was started until the resist was stripped off (resist strip time) was measured. Herein, the organic solvent was supplied to the two fluid nozzle 13 at a flow rate of 100 ml/min and a nitrogen gas was also supplied at a flow rate of 80 l/min. The time since the supply of the jet of droplets was started until the resist was stripped off was 220 seconds and the time is shortened by 110 seconds in comparison with the time measured in the test A4.

In FIG. 5, the times measured in the tests A1 through A4 are indicated in a line graph (chemical only), and the times measured in the tests B1 through B4 are indicted by a line graph (spray cleaning+chemical). A difference between the time measured in the test A1 and the time measured in the test B1, a difference between the time measured in the test A2 and the time measured in the test B2, a difference between the time measured in the test A3 and the time measured in the test B3, and a difference between the time measured in the test A4 and the time measured in the test B4 are indicted in a bar graph.

It is understood from the results set forth in FIG. 5 that it takes longer to strip off the resist as the dose amount of As increases. Also, it is understood that by supplying a jet of droplets of the organic solvent to the surface of the wafer W before the SPM is supplied, a time needed to strip off the resist can be shorter than in a case where the SPM alone (chemical only) is kept supplied to the surface of the wafer W.

While one embodiment of the invention has been described, the invention can be implemented in embodiments other than the one described above. For example, in the embodiment above, DIW is supplied to the surface of the wafer W from the DIW nozzle 30 while a jet of the droplets is supplied to the surface of the wafer W from the two fluid nozzle 13. However, DIW may be kept supplied from the DIW nozzle 30 before a supply of a jet of droplets from the two fluid nozzle 13 is started. In addition, a liquid supplied to the surface of the wafer W while a jet of droplets is supplied to the surface from the two fluid nozzle 13 is not limited to DIW, and it may be a chemical, such as SPM and sulfuric acid. It is, however, preferable to use a liquid of the same kind as a liquid used to generate a jet of droplets.

Further, the wafer W is used as an example of the substrate. However, a substrate to be processed is not limited to the wafer W, and it may be a glass substrate for a liquid crystal display, a glass substrate for a plasma display, a glass substrate for an FED, an optical disc substrate, a magnetic disc substrate, a magneto-optical disc substrate, or a photomask substrate.

While the embodiments of the invention have been described in detail, it should be appreciated that these embodiments represent examples to provide clear understanding of the technical contents of the invention, and the invention is not limited to these examples. The sprit and the scope of the invention, therefore, are limited solely by the scope of the appended claims.

This application is based upon and claims the benefits of priorities from the prior Japanese Patent Application No. 2005-349676 filed with the Japanese Patent Office on Dec. 2, 2005 and the prior Japanese Patent Application No. 2006-275092 filed with the Japanese Patent Office on Oct. 6, 2006, the entire contents of which are incorporated herein by reference.

What is claimed is:

1. A substrate processing method, comprising:
a mixed fluid supplying step of supplying a mixed fluid obtained by mixing an organic solvent and a gas to a surface of a substrate; and
a resist strip liquid supplying step of supplying a resist strip liquid to the surface of the substrate after the mixed fluid supplying step for stripping off a resist from the surface of the substrate.

2. The substrate processing method according to claim 1, further comprising:
a substrate rotating step of rotating the substrate; and
a liquid supplying step of supplying a liquid to the surface of the substrate in parallel with the substrate rotating step,
wherein the liquid supplying step is performed in parallel with the mixed fluid supplying step.

3. The substrate processing method according to claim 1, wherein:
the resist strip liquid includes a mixed liquid of sulfuric acid and a hydrogen peroxide liquid.

4. The substrate processing method according to claim 1, wherein:
the mixed fluid supplying step is a step of supplying a jet of droplets obtained by mixing the gas and a liquid of the organic solvent.

5. The substrate processing method according to claim 1, wherein:
the mixed fluid supplying step is a step of supplying a mixed fluid obtained by mixing the gas and a vapor of the organic solvent.

6. A substrate processing apparatus, comprising:
a substrate holding mechanism that holds a substrate;
a mixed fluid supplying mechanism that generates a mixed fluid by mixing an organic solvent and a gas and supplies the mixed fluid to a surface of the substrate held by the substrate holding mechanism;
a resist strip liquid supplying mechanism that supplies a resist strip liquid to the surface of the substrate held by the substrate holding mechanism for stripping off a resist from the surface of the substrate; and
a control unit that controls the mixed fluid supplying mechanism and the resist strip liquid supplying mechanism, so that the resist strip liquid supplying mechanism supplies the resist strip liquid after the mixed fluid is supplied by the mixed fluid supplying mechanism.

7. The substrate processing apparatus according to claim 6, further comprising:
a substrate rotating mechanism that rotates the substrate held by the substrate holding mechanism; and
a liquid supplying mechanism that supplies a liquid to the surface of the substrate held by the substrate holding mechanism,
wherein the control unit controls the mixed fluid supplying mechanism, the substrate rotating mechanism, and the liquid supplying mechanism, so that the liquid is supplied to the surface of the substrate by the liquid supplying mechanism while the substrate is rotated in parallel with a supply of the mixed fluid by the mixed fluid supplying mechanism.
